(19) United States
(12) Patent Application Publication
(10) Pub. No.: US 2007/0143394 A1
(43) Pub. Date: Jun. 21, 2007

(54) Server based date/time coordinate system

(75) Inventors: James R. Van Eaton, Woodinville, WA (US); Jorge Pereira, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/314,230

(22) Filed: Dec. 21, 2005

(51) Int. Cl. G06F 15/16

(52) U.S. Cl. 709/203

(57) ABSTRACT

Various technologies and techniques are disclosed that improve the interpretation and display of schedule data on a client. A server stores the schedule information and a user time zone setting. A client requests the schedule information from the server. The server translates the schedule information into one or more data packets based on a coordinate system that is understood by the client. The client receives the data packets containing the schedule information. The client interprets the data packets in the coordinate format based on the agreed-upon coordinate system. The client displays the schedule information on a user interface.

### BACKGROUND

Applications today have a problem of delivering complex views that are based upon dates and times, such as calendar events, calendar appointments, and project plans. The traditional approach is to position time related elements by having the client computer translate date/time objects into its own coordinate system. In the case of web-based scheduling applications, a lot of code, such as Java code, often needs to be interpreted on the client. The translation process and/or display process can be rather unstable based upon the limitations of the client computer, such as the type of scripts the client computer's web browser supports or the system resources available on the client computer. Moreover, if the client computer's local date/time setting is incorrect, such as having a different time zone setting than the server computer, the entire calendar event and/or appointment view is rendered inappropriately and can cause the user to miss important events or appointments. Also, depending on regional support, the client computer may not be able to display alternative calendaring systems correctly.

### SUMMARY

Various technologies and techniques are disclosed that improve the interpretation and display of schedule data on a client. A server stores the schedule information. The same server or a different server stores a user time zone setting. A client requests the schedule information from the server. The server translates the schedule information into one or more data packets based on a coordinate system that is understood by the client. In one implementation, the data is stored in a data store in the coordinate system format. In another implementation, the data is stored in a data store in a different format and then translated to the coordinate system format prior to transmission to the client. The client receives the data packets containing the schedule information and interprets the data packets based on the agreed-upon coordinate system. The client displays the schedule information on a user interface.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of parts of a system of one implementation.

FIG. 2 is a high level process flow diagram for one implementation of the system of FIG. 1.

FIG. 3 is a process flow diagram for one implementation of FIG. 1 illustrating the use of a mapping algorithm to generate the coordinate data necessary to plot a calendar event view.

FIG. 4 is a logical diagram with a simulated screen for one implementation of the system for FIG. 1 which illustrates one option for a coordinate calendar event view.

FIG. 5 is a process flow diagram for one implementation of the system of FIG. 1 illustrating the use of the mapping algorithm software to generate the coordinate data necessary to plot a calendar appointment view.

FIG. 6 is a logical diagram with a simulated screen for one implementation of the system for FIG. 1 which illustrates one option for a coordinate daily calendar appointment view.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a coordinate system that improves the interpretation and display of schedule data on a client. A server translates schedule information into one or more data packets based on a coordinate system that is understood by the client. In one implementation, this coordinate system does not depend on and/or use the client's date/time setting. The client receives the data packets containing the schedule information and interprets the data packets based on the agreed-upon coordinate system. The client displays the schedule information on a user interface.

In one implementation, the computer accurately displays the correct date and time of an appointment when the client computer's date and time setting is incorrect. As a few non-limiting examples, the client computer's date can be incorrect when the user travels across different time zones, and when the date setting on the client computer resets to a default date after a software or hardware failure. In another implementation, the client computer displays the correct date and time of an appointment without having to execute a lot of interpreted scripting code to create a coordinate system to enable the schedule to be displayed.

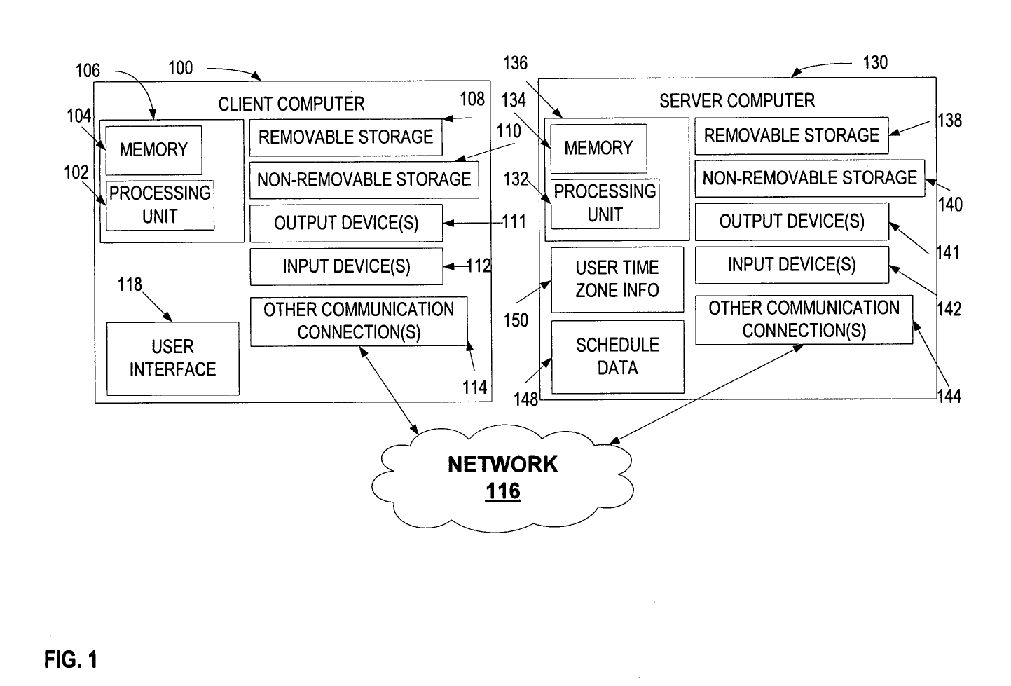

As shown in FIG. 1, an exemplary computer system to use for implementing one or more parts of the system includes one or more computing devices, such as computing devices 100 and/or 130. In its most basic configuration, computing devices 100 and/or 130 typically include at least one processing unit (102 and 132, respectively) and memory (104 and 134, respectively). Depending on the exact configuration and type of computing device, memory 104 or 134 may be volatile (such as RAM), non-volatile (such as ROM, flash memory, etc.) or some combination of the two. This most basic configuration is illustrated in FIG. 1 by lines 106 and 136.

Additionally, devices 100 and/or 130 may also have additional features/functionality. For example, devices 100 and/or 130 may also include additional storage (removable and/or non-removable) including, but not limited to, magnetic or optical disks or tape. Such additional storage is illustrated in FIG. 1 by removable storage (108 and 138, respectively) and non-removable storage (110 and 140, respectively). Computer storage media includes volatile and nonvolatile, removable and non-removable media implemented in any method or technology for storage of information such as computer readable instructions, data structures, program modules or other data. Memory 104 and 134, removable storage 108 and 138, and non-removable storage 110 and 140 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100 and/or 130. Any such computer storage media may be part of device 100 and/or 130.

Computing devices 100 and/or 130 include one or more communication connections that allow computing devices 100 and/or 130 to communicate with each other and/or one or more other computing devices (150, 160, and 170, respectively) over network 116. Communications connection(s) 114 and 144 are examples of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one implementation, computing device 100 is a client computer that communicates with server computer 130 using communication connection 114 and 144 over network 116. In such an implementation, user interface 1 18 of client computing device 100 accesses schedule data 148 and user time-zone information 150 on server computing device 130 to retrieve and display schedule information correctly. It will be appreciated that schedule data 148 and/or user time zone info 150 can be stored on the same server or different servers, but that they are shown on the same server computing device 130 for the sake of clarity. In one implementation, user interface 118 of client computing device 100 is a browser-based user interface, such as MICROSOFT® OUTLOOK® Web Access (OWA), and server computing device 130 is a web server, such as one having access to a data store using MICROSOFT® Exchange. In another implementation, user interface 118 of client computing device 100 is a user interface included in an executable program located on client computing device 100, such as MICROSOFT® Office OUTLOOK®, MICROSOFT® Project, or Lotus Notes.

Computing devices 100 and 130 may also have input device(s) (114 and 134, respectively) such as keyboard, mouse, pen, voice input device, touch input device, etc. Output device(s) (116 and 136, respectively) such as a display, speakers, printer, etc. may also be included. These devices are well known in the art and need not be discussed at length here.

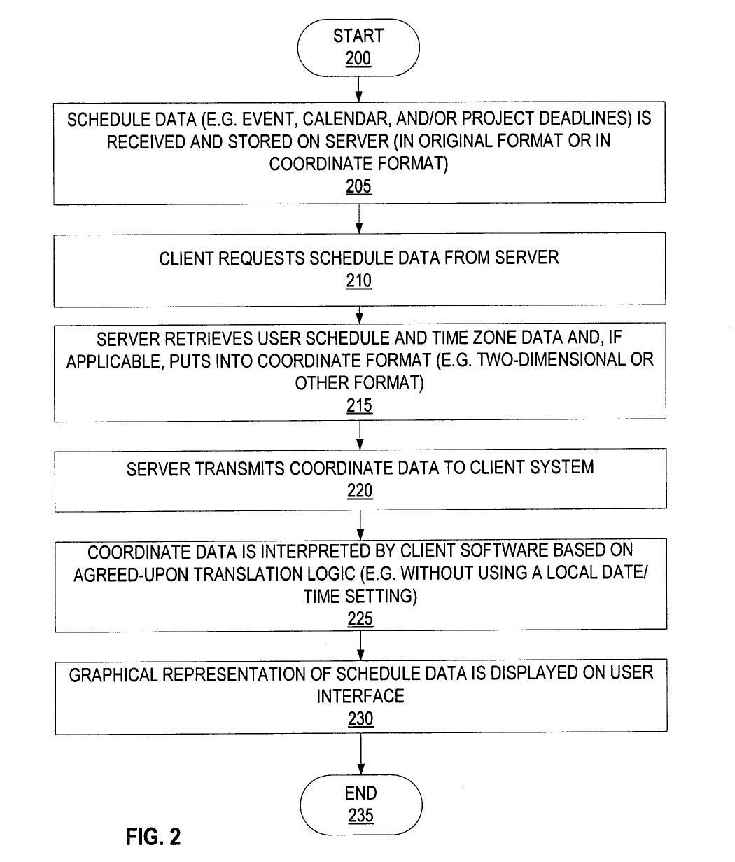

Turning now to FIG. 2 with continued reference to FIG. 1, a high level process flow for one implementation is presented. In one form, the process of FIG. 2 is at least partially implemented in the operating logic of computing device 100 and/or 130. The process begins at start point 200 with schedule data, such as event data, calendar data, and/or project deadline data, being received and stored on a server (stage 205). In one implementation, the schedule data is stored in a format prior other than the coordinate system format. In another implementation, the schedule data is stored in the coordinate system format (see stage 215).

The client requests the schedule data from the server (stage 210). The server retrieves the schedule data and translates it into a coordinate system format, if it is not already in the coordinate system format (stage 215). In one implementation, the server retrieves the user's time zone information, and uses the time zone information to help with translating the schedule data into the coordinate system format. In one implementation, the coordinate system format is a two-dimensional representation of the data. More or fewer dimensions and/or other ways for representing data in a coordinate format could also be used. The server transmits the coordinate data to the client (stage 220). The coordinate data is interpreted by the client computer based upon the agreed-upon translation logic (stage 225). In one implementation, the client's local date and time setting is not used in interpreting the schedule data, because the coordinates are not based upon dates and times. A graphical representation of the schedule data is displayed on the user interface to the user (stage 230).

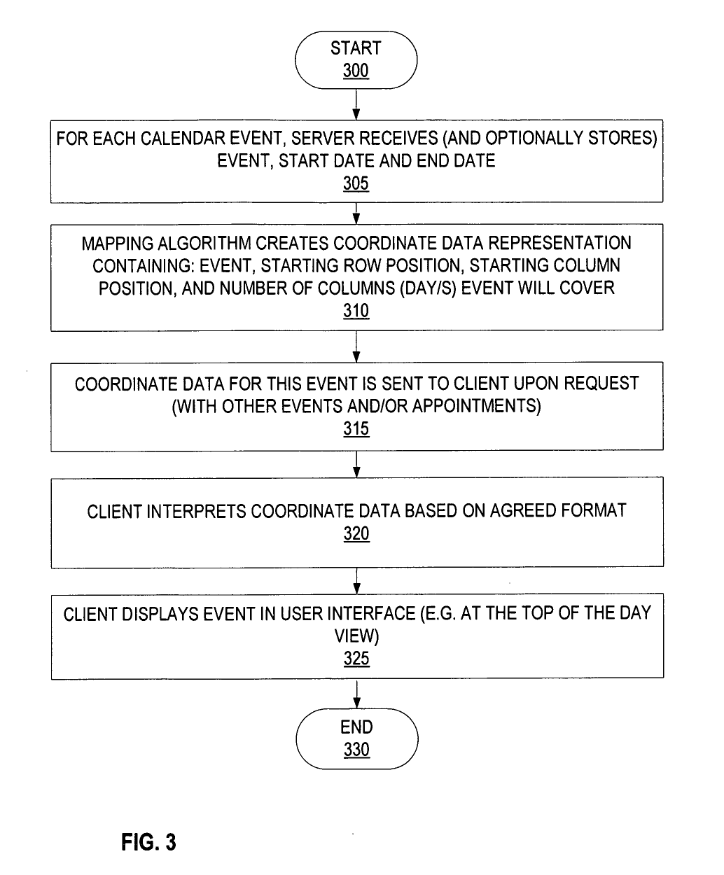

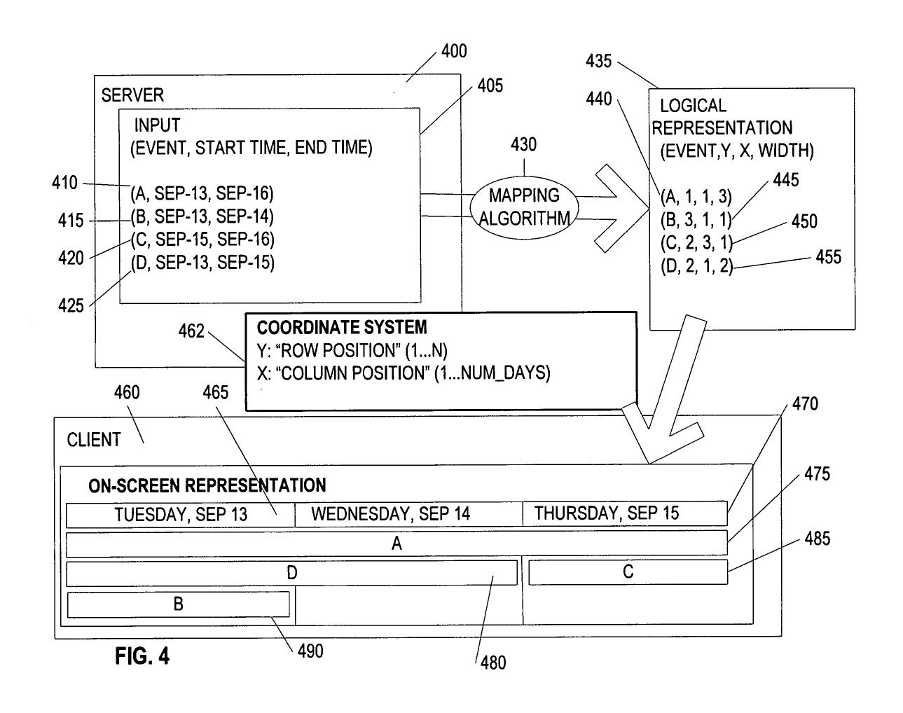

Turning now to FIGS. 3-4, with continued reference to FIGS. 1 and 2, a flow diagram and logical diagram with a simulated screen are shown to illustrate an exemplary scenario that uses the coordinate system for calendar event data. In one form, the process of FIG. 3 is at least partially implemented in the operating logic of computing device 100 and/or 130. The process begins at start point 300 with the server receiving and optionally storing an event, start date, and event date for each calendar event (stage 305). A mapping algorithm is used to create the coordinate representation for each event that contains the event, starting row position, starting column position, and number of columns (day/s) the event will cover (stage 310). The coordinate data for the event is sent to the client upon request, along with other events and/or appointments as applicable (stage 315). The client computer interprets the coordinate data based upon an agreed format (stage 320). The client computer displays the event in a user interface, such as at the top of the day view (stage 325). The process then ends at end point 330.

FIG. 4 is a logical diagram and simulated screen illustrating an exemplary coordinate system used to transmit event data from the server to the client for display on the client. Server 400 receives various event input data 405 (labeled 410, 415, 420, and 425, respectively). Mapping algorithm translates input data 405 into a logical representation 435 based on the coordinate system. For example, event data 410 is translated into event data 440, event data 415 is translated into event data 445, event data 420 is translated into event data 450, and event data 425 is translated into event data 455. Logical representation 435 is ordered by event, Y coordinate, X coordinate, and column width (e.g. number of days). The client 460 is aware of the coordinate system 462 and uses the coordinate system 462 to translate the logical representation 435 into the format for display on the user interface.

The event value in each coordinate record includes the name or other identifier for the event. The Y value includes the row position information. The X value includes the column position information. The width value is based on how many days of the total number of days being displayed the particular event spans. For example, event A (475) spans three days, and starts with Tuesday, September 13 (465) and continues through Thursday, September 15 (470). Hence, event A (475) has a width numeric value of 3. Event B (490) only spans a single day, and is displayed as the third event, based on the Y coordinate. Event C (485) only spans a single day and is displayed as the second event for Thursday, September 15. Event D (480) spans two days and is shown as the second event for each day, based on the Y coordinate.

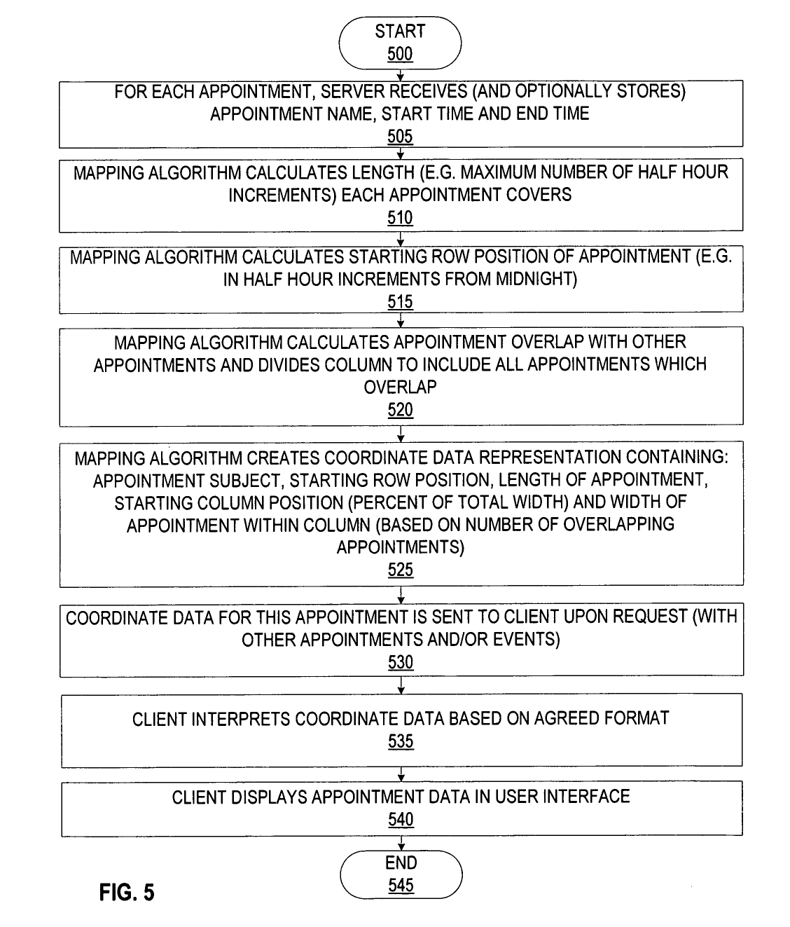

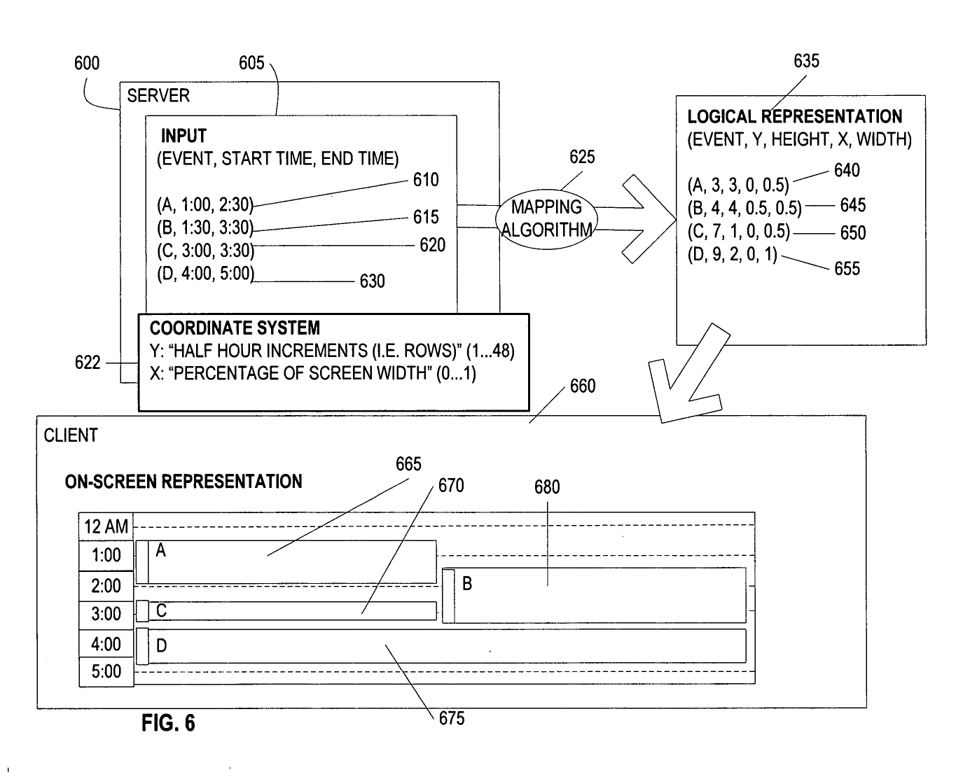

Turning now to FIGS. 5-6, with continued reference to FIGS. 1 and 2, a flow diagram and logical diagram with a simulated screen are shown to illustrate an exemplary scenario that uses the coordinate system for calendar appointment data. In one form, the process of FIG. 5 is at least partially implemented in the operating logic of computing device 100 and/or 130. The process begins at start point 500 with the server receiving and optionally storing an appointment name, start time, and end time for each calendar event (stage 505). A mapping algorithm calculates the length that each appointment covers (stage 510). In one implementation, the length is based on the maximum number of half hour increments contained for that day. The mapping algorithm calculates the starting row position of the appointment (stage 515), such as based on half hour increments from midnight. The mapping algorithm also calculates appointment overlap with other appointments and divides the column to include all appointments which overlap (stage 520).

The mapping algorithm creates a coordinate data representation for each appointment data record, including the appointment subject/description, starting row position, length of the appointment, starting position within the column (e.g. percent of total width), and the width of the appointment within the column (e.g. based on the number of overlapping appointments (stage 525). The coordinate data for the appointment is sent to the client upon request, along with other events and/or appointments as applicable (stage 530). The client computer interprets the coordinate data based upon an agreed format (stage 535). The client computer displays the appointment in a user interface (stage 540). The process then ends at end point 545.

FIG. 6 is a logical diagram and simulated screen illustrating an exemplary coordinate system used to transmit appointment data from the server to the client for display on the client. Server 600 receives various appointment input data 605 (labeled 610, 615, 620, and 630, respectively). Mapping algorithm translates input data 605 into a logical representation 635 based on the coordinate system. For example, appointment data 610 is translated into appointment data 640, appointment data 615 is translated into appointment data 645, appointment data 620 is translated into appointment data 650, and appointment data 630 is translated into appointment data 655. Logical representation 635 is ordered by event, Y coordinate, height, X coordinate, and column width (e.g. percent of column). The client 660 is aware of the coordinate system 662 and uses the coordinate system 662 to translate the logical representation 635 into the format for display on the user interface.

The appointment value in each coordinate record includes the name or other identifier for the event. The Y value includes the row position information, in half hour increments. The height value includes the number of half hour increments that the appointment spans. The X value includes the column position information, based on percentage of screen width. The width value indicates how wide the appointment should be, and is based on how many other appointments are being shown for the same time range. For example, appointment A (665) has an overlapping time period with appointment B (680), and thus appointment A (665) only takes up half of the screen width. Appointment A (665) spans three time periods of thirty minutes each. Thus, appointment A (665) has a height numeric value of 3. Appointment C (690) only spans a single time span, but has a period that overlaps with appointment B (680). Appointment D (675) does not have an overlapping time span, and takes up the entire column width.

The examples in FIGS. 3-6 are for purposes of illustration only, and are not limiting in nature. For example, other variations are also possible, such as using the technologies and techniques discussed herein for interpreting and displaying schedule information for a project planning application, such as MICROSOFT® Project. Other examples can include any type of application that deals with date and/or time sensitive information for display on a schedule.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
receiving a request from a client to retrieve at least one schedule entry;
retrieving the at least one schedule entry from a data store;
translating the schedule entry into a set of coordinates; and
sending the set of coordinates to the client for the client to interpret based on an agreed coordinate structure and display on a user interface.

2. The computer-readable medium of claim 1, wherein the translating step is performed before the retrieving step and wherein the retrieving step retrieves the set of coordinates.

3. The computer-readable medium of claim 1, wherein the translating step is performed after the retrieving step.

4. The computer-readable medium of claim 1, wherein a time zone setting for a user is used as part of the translating step.

5. The computer-readable medium of claim 1, wherein the client is a browser based application.

6. The computer-readable medium of claim 1, wherein the at least one schedule entry is an event.

7. The computer-readable medium of claim 1, wherein the at least one schedule entry is an appointment.

8. The computer-readable medium of claim 1, wherein the at least one schedule entry is associated with a project schedule.

9. A computer-readable medium having computer-executable instructions for causing a computer to perform steps comprising:
receiving a request from a user to access a schedule;
sending a request to a server for at least one schedule entry associated with the schedule;
receiving a response from the server, the response including at least one coordinate data packet representing the at least one schedule entry;
interpreting the at least one coordinate data packet based on a translation logic; and
displaying the translated schedule entry on a user interface.

10. The computer-readable medium of claim 9, wherein the coordinate data packet is interpreted without using a local date setting.

11. A method for providing a schedule comprising the steps of:
receiving a request to access a schedule of a user;
sending a request to a server for at least one schedule entry associated with the schedule;
receiving at least one coordinate data packet representing the at least one schedule entry in a format that is date independent;
interpreting the at least one coordinate data packet based on a translation logic; and
displaying the translated schedule entry on a user interface.

12. The method of claim 11, wherein the schedule entry is a calendar event.

13. The method of claim 11, wherein the schedule entry is a calendar appointment.

14. The method of claim 11, wherein the schedule entry is associated with a project schedule.

15. The method of claim 11, wherein the server is a web server.

16. The method of claim 11, wherein the user interface is displayed in a web browser.

17. The method of claim 11, wherein the coordinate data packet includes two-dimensional data.

18. The method of claim 11, wherein the coordinate data packet comprises an event description, a starting row position, a starting column position, and a number of columns the event will cover.

19. The method of claim 11, wherein the coordinate data packet comprises an appointment description, a starting row position, an appointment length, a starting column position, and a column width.

20. A computer-readable medium having computer-executable instructions for causing a computer to perform the steps recited in claim 11.
